(19) United States
(12) Patent Application Publication
(10) Pub. No.: US 2009/0269565 A1
(43) Pub. Date: Oct. 29, 2009

(54) POLYMERIC LAMINATES INCLUDING NANOCLAY

(76) Inventor: Richard Peng, Fishers, IN (US)

Correspondence Address: BRIDGESTONE AMERICAS, INC., 1200 FIRESTONE PARKWAY, AKRON, OH, 44317, US

(21) Appl. No.: 12/301,377

(22) PCT Filed: May 18, 2007
(86) PCT No.: PCT/US07/11922

§ 371 Date: Dec. 11, 2008

Related U.S. Application Data
(60) Provisional application No. 60/801,450, filed on May 18, 2006.

(51) Int. Cl. B32B 27/32; B32B 27/08; D03D 9/00; C08K 3/34

(52) U.S. Cl. 428/220; 428/515; 428/339; 442/1; 524/445

(57) ABSTRACT

A flexible polymeric laminate comprising a first layer including a thermoplastic resin having a nanoclay dispersed therein, and a second layer including a thermoplastic resin having a filler dispersed therein, where said filler includes less than 1% by weight nanoclay.

This application claims the benefit U.S. Provisional Application No. 60/801,450 filed on May 18, 2006, which are incorporated herein by reference.

### FIELD OF THE INVENTION

One or more embodiments of the present invention are directed toward polymeric laminates including at least one layer that includes a nanoclay.

### BACKGROUND OF THE INVENTION

Many roofs, especially flat or low-sloped roofs, are covered with a polymeric membrane. Polymeric membranes used in these applications include both thermoset membranes and thermoplastic membranes. Exemplary thermoset membranes include EPDM rubber. Thermoplastic membranes include PVC membranes and olefinic-based thermoplastic membranes. Olefinic-Based thermoplastic membranes offer unique advantages, including the ability to extrude the membrane, which facilitates manufacturing, and the ability to heat weld the membranes to form a continuous water barrier on the roofing surface.

Because the olefinic-based membranes are rich in hydrocarbon content, they may require significant flame retardants to pass industry and governmental flame and/or fire standards. The use of these flame retardants can have some drawbacks including cost and loss of mechanical properties.

In addition to improving flame and/or fire performance, there is also a desire to improve the oil resistance, UV resistance, and the oxygen permeability of these membranes

### SUMMARY OF THE INVENTION

One or more embodiments of the present invention provide a flexible polymeric laminate comprising a first layer including a thermoplastic resin having a nanoclay dispersed therein, and a second layer including a thermoplastic resin having a filler dispersed therein, where said filler includes less than 1% by weight nanoclay.

One or more embodiments of the present invention also provides a flexible polymeric laminate comprising a first layer including an olefinic thermoplastic resin, from about 3 to about 10% by weight of a nanoclay, and a flame retardant, a second layer including a thermoplastic resin and less than 3% by weight of a nanoclay, and a reinforcing scrim.

One or more embodiments of the present invention further provides a roofing membrane comprising at least one polymeric layer including an olefinic thermoplastic polymer, a nanoclay, and a flame retardant that forms a char layers when placed in contact with a flame.

### BRIEF DESCRIPTION OF THE DRAWINGS

FIG. 1 is a perspective, cross sectional view of a membrane according to one or more embodiments of the present invention;

FIG. 2 is a perspective, cross sectional view of a membrane according to one or more embodiments of the present invention; and

FIG. 3 is a perspective, cross sectional view of a build-up roof including a roofing membrane according to one or more embodiments of the present invention.

### DETAILED DESCRIPTION OF ILLUSTRATIVE EMBODIMENTS

The laminates of one or more embodiments of the present invention, which laminates may also be referred to as polymeric laminates or flexible laminates, include a layer including a nanoclay and another layer that is devoid of or only includes limited amounts of nanoclay. In one or more embodiments, the layer including the nanoclay may also include a flame retardant. In particular embodiments, the flame retardant includes a char-forming flame retardant. Despite the presence of the nanoclay, the laminates of one or more embodiments of the present invention are flexible and have been unexpectedly found to be technologically useful as roofing membranes and geomembranes.

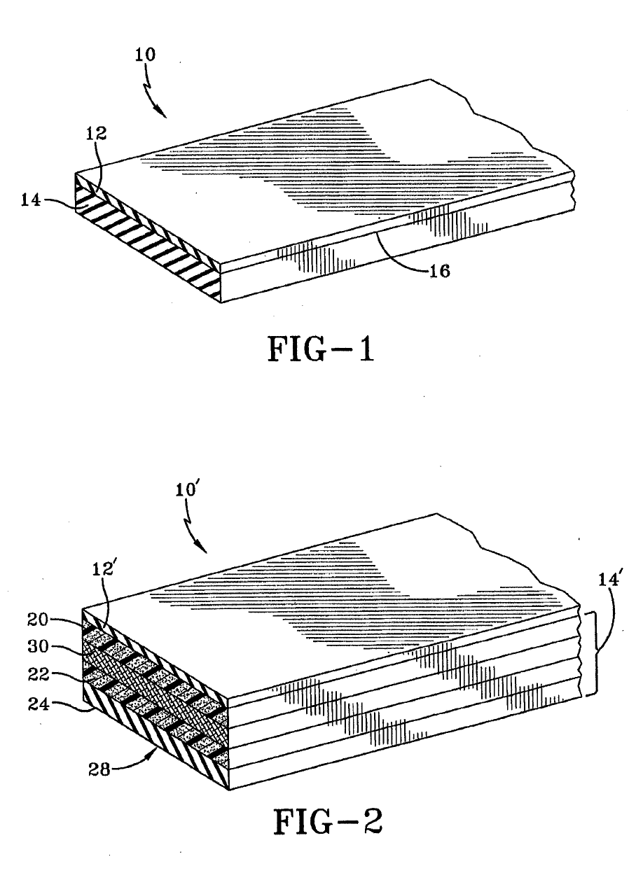

As shown in FIG. 1, an exemplary laminate 10 includes layer 12 and layer 14. In one or more embodiments, layer 12, which may be referred to as cap layer 12, includes nanoclay. In one or more embodiments, layer 12 and layer 14 are adjacent to one another and contact each other along an interfacing planar surface 16. In one or more embodiments, the interfacing planar surface may be an integral surface such may result from co-extrusion or a mated surface such as may result by heat calendaring the layers together.

In certain embodiments, layer 14 may include two or more sub-layers. For example, and as is shown in FIG. 2, membrane 10′ includes cap layer 12′ and sub-layers 14′. Sub-layers 14 include first inner-liner layer 20, second inner-liner layer 22, and base layer 24. Also shown is optional reinforcement layer 30. In certain embodiments, reinforcement layer 30 can be positioned between second inner-liner layer 22 and base layer 24. In other embodiments, reinforcement layer 30 may not be present. In these or other embodiments, a reinforcing fleece may be secured to the underside 28 of base layer 24.

Nanoclays may include smectite clays, which may also be referred to as layered silicate minerals or swellable smectite clays, as well as the intercalated or organically intercalated versions thereof, which may also be referred to as treated clays. In one or more embodiments, these clays include exchangeable cations that can be treated with organic swelling agents such as organic ammonium ions, to intercalate the organic molecules between adjacent planar silicate layers, thereby substantially increasing the interlayer spacing. It is believed that the expansion of the interlayer distance of the layered silicate can facilitate the intercalation of the clay with other materials. The interlayer spacing of the silicates can be further increased by formation of polymerized monomer chains between the silicate layers. In one or more embodiments, the intercalated silicate platelets are believed to act as nano-scale (sub-micron size) filler for the polymer.

In one or more embodiments, intercalation of the silicate layers in the clay can take place either by cation exchange or by absorption. For intercalation by absorption, dipolar functional organic molecules such as nitrile, carboxylic acid, hydroxy, and pyrrolidone groups may be present on the clay surface. Intercalation by absorption may take place when either acid or non-acid clays are used as the starting material. Cation exchange can take place if an ionic clay containing ions such as, for example, Na⁺, K⁺, Ca⁺⁺, Ba⁺⁺, and Li⁺ is used. Ionic clays can also absorb dipolar organic molecules.

Smectite clays include, for example, montmorillonite, saponite, beidellite, hectorite, and stevensite. In one or more embodiments, the space between silicate layers may be from about 15 to about 40 Å, and in other embodiments from about 17 to about 36 Å, as measured by small angle X-ray scattering. In one or more embodiments, clay with exchangeable cations such as sodium, calcium and lithium ions may be used. Montmorillonite in the sodium exchanged form is employed in one or more embodiments.

Organic swelling agents that can be used to treat the clay include quaternary ammonium compounds, protonated amines, organic phosphonium ions, and/or aminocarboxylic acids. One or more of these swelling agents can be used.

Useful treated clays are commercially available. For example, treated nanoclay is available from Sud-Chemie under the tradename Nanofil™ SE 3000.

In one or more embodiments, the layer including the nanoclay also includes a thermoplastic polymer. In these or other embodiments, each layer of the laminates of the present invention includes a thermoplastic polymer. Thermoplastic polymers include those polymers that are melt processable by employing one or more standard melt processing techniques such as melt extruding. In one or more embodiments, thermoplastic polymers include olefinic thermoplastic polymers, which include those thermoplastic polymers that are synthesized from (or derive from) the polymerization of one or more olefins.

In one or more embodiments, the thermoplastic polymer may be characterized by a melting point greater than 120° C. and in other embodiments greater than 130° C. In one or more embodiments, the thermoplastic polymer may be characterized by a crystallinity that is greater than 1%, in other embodiments greater than 10%, in other embodiments greater than 20%, in other embodiments greater than 30%, an in other embodiments greater than 40%.

In one or more embodiments, the thermoplastic polymer employed in one more layers of the laminates of the present invention may include a blend of olefinic polymers. Useful blends include those described in International Application No. PCT/US06/033522 which is incorporated herein by reference. For example, a particular blend may include (i) a plastomer, (ii) a low density polyethylene, and (iii) a propylene-based polymer.

In one or more embodiments, the plastomer includes an ethylene-α-olefin copolymer. The plastomer employed in one or more embodiments of this invention includes those described in U.S. Pat. Nos. 6,207,754, 6,506,842, 5,226,392, and 5,747,592, which are incorporated herein by reference. This copolymer may include from about 1.0 to about 15 mole percent, in other embodiments from about 2 to about 12, in other embodiments from about 3 to about 9 mole percent, and in other embodiments from about 3.5 to about 8 mole percent mer units deriving from α-olefins, with the balance including mer units deriving from ethylene. The α-olefin employed in preparing the plastomer of one or more embodiments of this invention may include butene-1, pentene-1, hexene-1, octene-1, or 4-methyl-pentene-1.

The plastomer of one or more embodiments of this invention can be characterized by a density of from about 0.865 g/cc to about 0.900 g/cc, in other embodiments from about 0.870 to about 0.890 g/cc, and in other embodiments from about 0.875 to about 0.880 g/cc per ASTM D-792. In these or other embodiments, the density of the plastomers may be less than 0.900 g/cc, in other embodiments less than 0.890 g/cc, in other embodiments less than 0.880 g/cc, and in other embodiments less than 0.875 g/cc.

In one or more embodiments, the plastomer may be characterized by a weight average molecular weight of from about 7×10⁴ to 13×10⁴ g/mole, in other embodiments from about 8×10⁴ to about 12×10⁴ g/mole, and in other embodiments from about 9×10⁴ to about 11×10⁴ g/mole as measured by using GPC with polystyrene standards. In these or other embodiments, the plastomer may be characterized by a weight average molecular weight in excess of 5×10⁴ g/mole, in other embodiments in excess of 6×10⁴ g/mole, in other embodiments in excess of 7×10⁴ g/mole, and in other embodiments in excess of 9×10⁴ g/mole. In these or other embodiments, the plastomer may be characterized by a molecular weight distribution (M_{w}/Mₙ) that is from about 1.5 to 2.8, in other embodiments 1.7 to 2.4, and in other embodiments 2 to 2.3.

In these or other embodiments, the plastomer may be characterized by a melt index of from about 0.1 to about 8, in other embodiments from about 0.3 to about 7, and in other embodiments from about 0.5 to about 5 per ASTM D-1238 at 190° C. and 2.16 kg load.

The uniformity of the comonomer distribution of the plastomer of one or more embodiments, when expressed as a comonomer distribution breadth index value (CDBI), provides for a CDBI of greater than 60, in other embodiments greater than 80, and in other embodiments greater than 90.

In one or more embodiments, the plastomer may be characterized by a DSC melting point curve that exhibits the occurrence of a single melting point break occurring in the region of 50 to 110° C.

The plastomer of one or more embodiments of this invention may be prepared by using a single-site coordination catalyst including metallocene catalyst, which are conventionally known in the art.

Useful plastomers include those that are commercially available. For example, plastomer can be obtained under the tradename EXXACT™ 8201 (ExxonMobil); or under the tradename ENGAGE™ 8180 (Dow DuPont).

In one or more embodiments, the low density polyethylene includes an ethylene-α-olefin copolymer. In one or more embodiments, the low density polyethylene includes linear low density polyethylene. The linear low density polyethylene employed in one or more embodiments of this invention may be similar to that described in U.S. Pat. No. 5,266,392, which is incorporated herein by reference. This copolymer may include from about 2.5 to about 13 mole percent, and in other embodiments from about 3.5 to about 10 mole percent, mer units deriving from α-olefins, with the balance including mer units deriving from ethylene. The α-olefin included in the linear low density polyethylene of one or more embodiments of this invention may include butene-1, pentene-1, hexene-1, octene-1, or 4-methyl-pentene-1. In one or more embodiments, the linear low density polyethylene is devoid or substantially devoid of propylene mer units (i.e., units deriving from propylene). Substantially devoid refers to that amount or less of propylene mer units that would otherwise have an appreciable impact on the copolymer or the compositions of this invention if present.

The linear low density polyethylene of one or more embodiments of this invention can be characterized by a density of from about 0.885 g/cc to about 0.930 g/cc, in other embodiments from about 0.900 g/cc to about 0.920 g/cc, and in other embodiments from about 0.900 g/cc to about 0.910 g/cc per ASTM D-792.

In one or more embodiments, the linear low density polyethylene may be characterized by a weight average molecular weight of from about 1×10⁵ to about 5×10⁵ g/mole, in other embodiments 2×10⁵ to about 10×10⁵ g/mole, in other embodiments from about 5×10⁵ to about 8×10⁵ g/mole, and in other embodiments from about 6×10⁵ to about 7×10⁵ g/mole as measured by GPC with polystyrene standards. In these or other embodiments, the linear low density polyethylene may be characterized by a molecular weight distribution (M_{w}/Mₙ) of from about 2.5 to about 25, in other embodiments from about 3 to about 20, and in other embodiments from about 3.5 to about 10. In these or other embodiments, the linear low density polyethylene may be characterized by a melt flow rate of from about 0.2 to about 10 dg/min, in other embodiments from about 0.4 to about 5 dg/min, and in other embodiments from about 0.6 to about 2 dg/min per ASTM D-1238 at 230° C. and 2.16 kg load.

The linear low density polyethylene of one or more embodiments of this invention may be prepared by using a convention Ziegler Natta coordination catalyst system.

Useful linear low density polyethylene includes those that are commercially available. For example, linear low density polyethylene can be obtained under the tradename Dowlex™ 2267G (Dow); or under the tradename DFDA-1010 NT7 (Dow).

In one or more embodiments, a functionalized low density polyethylene resin can be used in addition to or in lieu of the linear low density polyethylene. Functionalized low density polyethylene resins may include from about 1.0 to about 7, in other embodiments from about 2 to about 6, and in other embodiments form about 3 to about 5 mole % mer units that include a functional group. The functional group, which may include a pendant moiety, may include an acid or anhydride group. These acid or anhydride groups may derive from unsaturated carboxylic acids or unsaturated anhydrides. Examples of unsaturated carboxylic acids include citraconic acid, cinnamic acid, methacrylic acid, and itaconic acid. Examples of unsaturated anhydrides include maleic anhydride, citraconic anhydride, and itaconic anhydride. The resin can be functionalized by copolymerizing unsaturated carboxylic acids or unsaturated anhydrides together with other monomer to form the polymer backbone, or the unsaturated carboxylic acids or unsaturated anhydrides can be subsequently grafted to the polymer backbone.

Functionalized low density polyethylene resins are commercially available. For example, they can be obtained under the commercial name FUSABOND™ MB 226D (DuPont).

In one or more embodiments, the propylene-based polymer may include polypropylene homopolymer or copolymers of propylene and a comonomer, where the copolymer includes, on a mole basis, a majority of mer units deriving from propylene. In one or more embodiments, the propylene-based copolymers may include from about 2 to about 6 mole percent, and in other embodiments from about 3 to about 5 mole percent mer units deriving from the comonomer with the remainder including mer units deriving from propylene. In one or more embodiments, the comonomer includes at least one of ethylene and an α-olefin. The α-olefins may include butene-1, pentene-1, hexene-1, oxtene-1, or 4-methyl-pentene-1. In one or more embodiments, the copolymers of propylene and a comonomer may include random copolymers. Random copolymers may include those propylene-based copolymers where the comonomer is randomly distributed across the polymer backbone.

The propylene-based polymers employed in one or more embodiments of this invention may be characterized by a melt flow rate of from about 0.5 to about 15 dg/min, in other embodiments from about 0.7 to about 12 dg/min, in other embodiments from about 1 to about 10 dg/min, and in other embodiments from about 1.5 to about 3 dg/min per ASTM D-1238 at 230° C. and 2.16 kg load. In these or other embodiments, the propylene-based polymers may have a weight average molecular weight (M_{w}) of from about 1×10⁵ to about 5×10⁵ g/mole, in other embodiments from about 2×10⁵ to about 4×10⁵ g/mole, and in other embodiments from about 3×10⁵ to about 4×10⁵ g/mole, as measured by GPC with polystyrene standards. The molecular weight distribution of these propylene-based copolymer may be from about 2.5 to about 4, in other embodiments from about 2.7 to about 3.5, and in other embodiments from about 2.8 to about 3.2.

In one or more embodiments, propylene-based polymers may be characterized by a melt temperature (Tₘ) that is from about 165° C. to about 130° C., in other embodiments from about 160 to about 140° C., and in other embodiments from about 155° C. to about 140° C. In one or more embodiments, particularly where the propylene-based polymer is a copolymer of propylene and a comonomer, the melt temperature may be below 160° C., in other embodiments below 155° C., in other embodiments below 150° C., and in other embodiments below 145° C. In one or more embodiments, they may have a crystallization temperature (T_{C}) of about at least 90° C., in other embodiments at least about 95° C., and in other embodiments at least 100° C., with one embodiment ranging from 105° to 115° C.

Also, these propylene-based polymers may be characterized by having a heat of fusion of at least 25 J/g, in other embodiments in excess of 50 J/g, in other embodiments in excess of 100 J/g, and in other embodiments in excess of 140 J/g.

In one or more embodiments, the propylene-based polymers may be characterized by a flexural modulus, which may also be referred to as a 1% secant modulus, in excess of 120,000 psi, in other embodiments in excess of 125,000, in other embodiments in excess of 130,000 psi, in other embodiments in excess of 133,000 psi, in other embodiments in excess of 135,000 psi, and in other embodiments in excess of 137,000 psi, as measured according to ASTM D-790.

Useful propylene-based polymers include those that are commercially available. For example, propylene-based polymers can be obtained under the tradename PP7620Z™ (Fina), PP33BF01™ (Equistar), or under the tradename TR3020™ (Sunoco).

In one or more embodiments, the thermoplastic polymer employed in one more layers of the laminates of the present invention may include an olefinic reactor copolymer. Reactor copolymers are generally known in the art and may include blends of olefinic polymers that result from the polymerization of ethylene and α-olefins with sundry catalyst systems. In one or more embodiments, these blends are made by in-reactor sequential polymerization. Reactor copolymers useful in one or more embodiments include those disclosed in U.S. Pat. No. 6,451,897, which is incorporated therein by reference.

In one or more embodiments, the thermoplastic polymer employed in one more layers of the laminates of the present invention may include a functionalized thermoplastic polymer. Functionalized thermoplastic polymers may include from about 1.0 to about 7, in other embodiments from about 2 to about 6, and in other embodiments form about 3 to about 5 weight % mer units that include a functional group. The functional group, which may include a pendant moiety, may include an acid or anhydride group. These acid or anhydride groups may derive from unsaturated carboxylic acids or unsaturated anhydrides. Examples of unsaturated carboxylic acids include citraconic acid, cinnamic acid, methacrylic acid, and itaconic acid. Examples of unsaturated anhydrides include maleic anhydride, citraconic anhydride, and itaconic anhydride. The resin can be functionalized by copolymerizing unsaturated carboxylic acids or unsaturated anhydrides together with other monomer to form the polymer backbone, or the unsaturated carboxylic acids or unsaturated anhydrides can be subsequently grafted to the polymer backbone.

Functionalized low density polyethylene resins are commercially available. For example, they can be obtained under the commercial name FUSABOND™ MB 226D (DuPont) or KRAYTON FG 1901X.

In one or more embodiments, a compatibilizing agent is used in lieu of or in addition to a functionalized polyolefin. It is believed that the functionalized polyolefin and/or compatibilizing agent improve the thermoplastic polymers compatibility with the nanoclay. Useful compatibilizing agents include carboxylic acids and anhydrides. Examples of unsaturated carboxylic acids include citraconic acid, cinnamic acid, methacrylic acid, and itaconic acid. Examples of unsaturated anhydrides include maleic anhydride, citraconic anhydride, and itaconic anhydride.

In one or more embodiments, flame retardants may include any compound that will increase the burn resistivity, particularly flame spread such as tested by UL 94 and/or UL 790, of the laminates of the present invention. Useful flame retardants include those that operate by forming a char-layer across the surface of a specimen when exposed to a flame. Other flame retardants include those that operate by releasing water upon thermal decomposition of the flame retardant compound. Useful flame retardants may also be categorized as halogenated flame retardants or non-halogenated flame retardants.

Exemplary non-halogenated flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), which is sold together as a polyol masterbatch, melamine polyphosphate is available under the tradename Budit™ 3141 (Budenheim), and antimony oxide (Sb₂O₃) is commercially available under the tradename Fireshield™. Those flame retardants from the foregoing list that are believed to operate by forming a char layer include ammonium polyphosphate and melamine polyphosphate.

In one or more embodiments, treated or functionalized magnesium hydroxide may be employed. For example, magnesium oxide treated with or reacted with a carboxylic acid or anhydride may be employed. In one embodiment, the magnesium hydroxide may be treated or reacted with stearic acid. In other embodiments, the magnesium hydroxide may be treated with or reacted with certain silicon-containing compounds. The silicon-containing compounds may include silanes, polysiloxanes including silane reactive groups. In other embodiments, the magnesium hydroxide may be treated with maleic anhydride. Treated magnesium hydroxide is commercially available. For example, Zerogen™ 50.

Examples of halogenated flame retardants may include halogenated organic species or hydrocarbons such as hexabromocyclododecane or N,N′-ethylene-bis-(tetrabromophthalimide). Hexabromocyclododecane is commercially available under the tradename CD-75P™ (ChemTura). N,N′-ethylene-bis-(tetrabromophthalimide) is commercially available under the tradename Saytex™ BT-93 (Albemarle).

In one or more embodiments, the use of char-forming flame retardants (e.g. ammonium polyphosphate and melamine polyphosphate) has unexpectedly shown advantageous results when used in conjunction with nanoclay within the cap layer of the laminates of the present invention. It is believed that there may be a synergistic effect when these compounds are present in the cap layer. As a result, the cap layer of the laminates of the certain embodiments of the present invention are devoid of or substantially devoid of halogenated flame retardants and/or flame retardants that release water upon thermal decomposition. Substantially devoid referring to that amount or less that does not have an appreciable impact on the laminates, the cap layer, and/or the burn resistivity of the laminates.

In one or more embodiments, one or more layers of the laminates of the present invention may include a processing aid. Processing aids include those compounds that can be added to the thermoplastic polymer composition to assist in processing or extend the polymeric materials. In one or more embodiments, processing aids include those compounds that can reduce the viscosity and/or increase the flow of the thermoplastic polymer. Exemplary processing aids include metal salts of carboxylic acids including metal salts of naturally occurring fats and oils. In one or more embodiments, processing aids include calcium stearate and/or zinc stearate. In other embodiments, processing aids include processing oils such as those that are conventional in plastics and/or rubber processing.

In one or more embodiments, the cap layer and/or one or more other layers of the laminates may also include a rubber. Rubbers include those polymers characterized by a crystallinity of less than 1%, in other embodiments less than 0.5%, and in other embodiments less than 0.1%. Exemplary rubbers include polymers of conjugated dienes, ethylene-propylene rubber, ethylene-propylene-diene rubber, butyl rubber, nitrile rubber, and mixtures thereof. In certain embodiments, the rubber includes those polymers that do not have a melting point.

In one or more embodiments, one or more layers of the laminates layer include a stabilizers. Stabilizers may include one or more of a UV stabilizer, an antioxidant, and an antiozonant. UV stabilizers include Tinuvin™ 622. Antioxidants include Irganox™ 1010.

In addition to the foregoing, one or more layers may also include other ingredients or constituents that are commonly included in polymeric compounds. These ingredients may include pigment such as TiO₂. In certain embodiments, especially where the membrane is employed as a geomembrane, carbon black may be employed as a pigment or reinforcement.

In one or more embodiments, each layer of the laminates of the present invention include sufficient thermoplastic polymer and/or sufficient thermoplastic polymer arranged in the appropriate morphology to render the one or more layers melt processable by employing one or more standard melt processing techniques such as melt extruding.

In one or more embodiments, the one or more layers of the laminates may include from about 5 to about 50% by weight, in other embodiments from about 10 to about 45% by weight, and in other embodiments from about 15 to about 38% by weight plastomer, based upon the total weight of the polymeric component of the polymeric layer, where the polymeric component refers to all polymeric constituents of the layer, (e.g., plastomer, low density polyethylene, and propylene-based polymer). In these or other embodiments, one or more layers may include at least 5% by weight, in other embodiments at least 10% by weight, and in other embodiments at least 15% by weight plastomer, based upon the total weight of the polymeric component of the polymeric layer; in these or other embodiments, one or more layers may include less than 50% by weight, in other embodiments less than 45% by weight, and in other embodiments less than 38% by weight plastomer based upon the total weight of the polymeric component of the polymeric layer. In one or more embodiments, one or more layers of the membranes of this invention include sufficient plastomer so as to be flexible at −40° C. In one or more embodiments, one or more layers includes sufficient plastomer so as to pass the brittle-point test of ASTM D-2137.

In one or more embodiments, one or more layers of the laminates of this invention may include from about 10 to about 90% by weight, in other embodiments from about 15 to about 85% by weight, and in other embodiments from about 25 to about 75% by weight low density polyethylene, based upon the total weight of the polymeric component of the polymeric layer. In these or other embodiments, one or more layers may include at least 31% by weight, in other embodiments at least 33% by weight, in other embodiments at least 35% by weight, and in other embodiments at least 40% by weight low density polyethylene (e.g., linear low density polyethylene), based upon the total weight of the polymeric component of the polymeric layer; in these or other embodiments, one or more layers may include less than 90% by weight, and in other embodiments less than 75% by weight low density polyethylene based upon the total weight of the polymeric component of the polymeric layer. In one or more embodiments, one or more layers of the membranes of this invention include sufficient low density polyethylene so as to provide high tensile and tear. In one or more embodiments, the layer includes sufficient low density polyethylene to provide elongation of at least 500% (ASTM D-412) and a Die-C tear of at least 525 newtons/cm per ASTM D-624.

In one or more embodiments, one or more layers of the laminates this invention may include from about 5 to about 50% by weight, in other embodiments from about 10 to about 45% by weight, and in other embodiments from about 15 to about 35% by weight propylene-based polymer, based upon the total weight of the polymeric component of the polymeric layer. In these or other embodiments, one or more layers may include at least 5% by weight, in other embodiments at least 10% by weight, and in other embodiments at least 15% by weight propylene-based polymer, based upon the total weight of the polymeric component of the polymeric layer; in these or other embodiments, one or more layers may include less than 50%, in other embodiments less than 49% by weight, and in other embodiments less than 45% by weight propylene-based polymer based upon the total weight of the polymeric component of the polymeric layer. In one or more embodiments, one or more layers of the membranes of this invention include sufficient propylene polymer so as to withstand 116° C. aging for 7 days, where membranes or layers that do not withstand these conditions will flow or deform. In one or embodiments, the cap layer of the laminates of the present invention includes sufficient nanoclay to improve the flame resistance (UL 790 and/or UL 94), oil resistance (ASTM 876 and UL-1581), oxygen permeability, long-term weathering, and/or water permeability (ASTM E96-B) of the laminates.

In one or more embodiments, the cap layer (e.g. cap layer 12) includes at least 1 weight percent, in other embodiments at least 2 weight percent, in other embodiments at least 3 weight percent, in other embodiments at least 5 weight percent, and in other embodiments at least 6 weight percent nanoclay based upon the total weight of the cap layer. In these or other embodiments, the cap layer 12 includes less than 12 weight percent, in other embodiments less than 10 weight percent, and in other embodiments less than 8 weight percent nanoclay based upon the total weight of the cap layer. In these or other embodiments, cap layer 12 includes from about 2 to about 10 weight percent, in other embodiments from about 3 to about 10 weight percent, and in other embodiments from about 5 to about 8 weight percent nanoclay based upon the total weight of the cap layer.

In one or more embodiments, the cap layer (e.g. layer 12), and in certain embodiments multiple layers of the membranes of the present invention, include sufficient flame retardant so that, when combined with the nanoclay, the membranes pass industry standards for flame spread and/or flammability. In one or more embodiments, one or more of the layers include sufficient flame retardant that when combined with the nanoclay allow the membrane to pass the flame spread test of UL-790 for unlimited slope.

In one or more embodiments, the use of the nanoclay advantageously allows for the use of less flame retardant than would otherwise be required to meet industry standards. In one or more embodiments, the cap layer includes less than 80%, in other embodiments less than 70%, in other embodiments less than 60%, and in other embodiments less than 50%, and in other embodiments from about 30 to about 70% of an amount of flame retardant that would otherwise be required to meet UL-790 in the absence of the nanoclay.

For example, where the cap layer includes a phosphate or phosphinate flame retardant, the cap layer may include less than 40, in other embodiments less than 35, in other embodiments less than 30, in other embodiments less than 25, and in other embodiments less than 23 percent by weight phosphate or phosphinate flame retardant. In these or other embodiments, where the cap layer includes a phosphate or phosphinate flame retardant, the cap layer may include at least 5, in other embodiments at least 10, in other embodiments at least 15, and in other embodiments at least 18 percent by weight phosphate or phosphinate flame retardant.

In certain embodiments, the cap layer includes from about 5 to about 50 weight percent, in other embodiments from about 10 to about 40 weight percent, and in other embodiments from about 15 to about 30 weight percent non-halogenated flame retardant, based upon the total weight of the cap layer.

In one or more embodiments, the cap layer includes from about 3 to about 30 weight percent, in other embodiments from about 5 to about 25 weight percent, and in other embodiments from about 10 to about 20 weight percent halogenated flame retardant based upon the total weight of the cap layer.

In one or more embodiments, the cap layer includes less than 1.0 weight percent, in other embodiments less than 0.5 weight percent, in other embodiments less than 0.2 weight percent, in other embodiments less than 0.1 weight percent, and in other embodiments at less than 0.05 weight percent processing aids, based upon the total weight of the cap layer. In one or more embodiments, cap layer 12, and in other embodiments both layers 12 and 14 are substantially devoid of processing aids, where substantially devoid refers to an amount less than that amount that would otherwise have an appreciable impact on the membrane or its processing period. In one or more embodiments, layer 12 and/or layer 14 are devoid of processing aids.

In one or more embodiments, the cap layer, and in these or other embodiments multiple layers of the laminate, may include from about 0.5 to about 20% by weight, in other embodiments from about 1 to about 10% by weight, and in other embodiments from about 2 to about 5% by weight rubber, based on the total weight of the layer.

In one or more embodiments, the cap layer, and in these or other embodiments multiple layers of the laminate, include less than 2% by weight, in other embodiments less than 1% by weight, in other embodiments less than 0.5% by weight, and in other embodiments less than 0.1% by weight rubber. In one or more embodiments, the layers are substantially devoid of rubber, where substantially devoid refers to less than that amount of rubber that would otherwise have an appreciable impact on the layer. In certain embodiments, one or more layers are devoid of rubber.

In or more embodiments, the cap layer is characterized by a torsional stiffness, at 25° C. as determined by ASTM D4065 using a Rheometric Dynamic Analyzer, of at least 3.5×10⁹ dynes/cm², in other embodiments at least 4.0×10⁹ dynes/cm², in other embodiments at least 4.5×10⁹ dynes/cm², and in other embodiments from about 2.5×10⁹ to about 6.0×10⁹ dynes/cm².

In or more embodiments, cap layer 12 is characterized by a melt temperature of from about 110° C. to about 170° C., in other embodiments from about 120° C. to about 160°, and in other embodiments from about 130° C. to about 150° C.

In one or more embodiments, cap layer 12 has a thickness of less than 30, in other embodiments less than 25, in other embodiments less than 20, and in other embodiments less than 15 mil; in these or other embodiments, the cap layer has a thickness of at least 4, in other embodiments at least 6, and in other embodiments at least 10 mil.

In one or more embodiments, at least one other layer of the laminate (e.g. layer 14), or in certain embodiments each of the other layers of the laminate, include less than 3 weight percent, in other embodiments less than 2 weight percent, in other embodiments less than 1 weight percent, and in other embodiments less than 0.5 weight percent, in other embodiments less than 0.1 weight percent, and in other embodiments less than 0.05 weight percent nanoclay based upon the total weight of the layer in question. In particular embodiments, the other layers of the laminate are substantially devoid, and in other embodiments devoid of nanoclay, where substantially devoid refers to that amount or less of nanoclay does not have an appreciable impact on the laminate or the individual layer thereof.

The fact that the laminates of the present invention may include compositionally distinct layers offers a number of advantages. For example, in certain embodiments less expensive polymers can be employed within inner layers 20 and 22. In certain embodiments, inner layers 20 and 22 may include low density polyethylene such as linear low density polyethylene as described hereinabove. Also, inner layers 20 and 22 may be devoid or substantially devoid of flame retardants and/or devoid or substantially devoid of nanoclay.

In certain embodiments, base layer 24 may include similar polymeric constituents to the cap layer (e.g. 12′). In certain embodiments, base layer 24 may likewise include nanoclay in a similar fashion to cap layer 12′. In other embodiments, base layer 24 and cap layer 12′ may be compositionally distinct based on the presence or absence of nanoclay.

Inasmuch as cap layer 12′ includes nanoclay, the presence of inner-liner layers 20 and 22 adjacent to reinforcement layer 30 provides a particular advantage. Inasmuch as cap layer 12′ includes nanoclay, the stiffness of cap layer 12′, as may be determined by Torsional modulus or flexural modulus, may be increased. Inasmuch as inner-liner layers 20 and 22 do not include nanoclay in certain embodiments, or are substantially devoid of nanoclay as described hereinabove, the stiffness of these layers, which are adjacent to reinforcement layer 30, is lower than that of cap layer 12′ thereby having an advantageous impact on the overall mechanical properties of the membrane.

In or more embodiments, at least one of the other layers of the laminates (e.g., inner layer 20 and/or 22) is characterized by a torsional stiffness, at 25° C. as determined by ASTM D4065 using a Rheometric Dynamic Analyzer, of less than 2.0×10⁹ dynes/cm², in other embodiments at least 1.5×10⁹ dynes/cm², in other embodiments at least 1.0×10⁹ dynes/cm², in other embodiments at least 0.7×10⁹ dynes/cm², in other embodiments at least 0.5×10⁹ dynes/cm², and in other embodiments from about 0.1×10⁹ to about 1.0×10⁹ dynes/cm².

In one or more embodiments, the reinforcement may include a woven or non-woven scrim or fabric. Included are those reinforcements conventionally employed in the art of making roofing membranes as disclosed in U.S. Application Nos. 60/712,070 and 60/774,349, which are incorporated herein by reference.

The thickness of the laminates of the present invention may vary depending upon the intended use of. For example, the laminates, such as the four-layered polymeric membrane as exemplified in FIG. 2, may have an overall thickness of from about 20 to about 100 mil, in other embodiments from about 40 to about 90 mil, and in other embodiments from about 45 to about 85 mil. In certain embodiments the overall membrane has a thickness of 45 mil, 60 mil, or 80 mil. In one or more embodiments, where the laminates are employed as roofing membranes, the membranes may have an overall thickness of from about 40 to about 80 mil. In one or more embodiments, where the laminates are employed as geomembranes, the membranes may have an overall thickness of from about 30 to about 120 mil.

In one or more embodiments, the laminates of the present invention may be prepared by extruding a polymeric composition into a sheet. Multiple sheets may be extruded and joined to form a laminate. A membrane including a reinforcing layer may be prepared by extruding at least one sheet on and/or below a reinforcement (e.g., a scrim). In other embodiments, the polymeric layer may be prepared as separate sheets, and the sheets may then be calendered with the scrim sandwiched therebetween to form a laminate. In one or more embodiments, the membranes of the present invention are prepared by employing co-extrusion technology. Useful techniques include those described in co-pending U.S. Ser. Nos. 11/708,898 and 11/708,903, which are incorporated herein by reference.

Following extrusion, and after optionally joining one or more polymeric layers, or optionally joining one or more polymeric layer together with a reinforcement, the membrane may be fabricated to a desired thickness. This may be accomplished by passing the membrane through a set of squeeze rolls positioned at a desired thickness. The membrane may then be allowed to cool and/or rolled for shipment and/or storage.

The polymeric composition that may be extruded to form the polymeric sheet may include the ingredients or constituents described herein. For example, the polymeric composition may include plastomer, low density polyethylene, propylene polymer, nanoclay and flame retardant. The ingredients may be mixed together by employing conventional polymer mixing equipment and techniques. In one or more embodiments, an extruder may be employed to mix the ingredients. For example, single-screw or twin-screw extruders may be employed.

In one embodiment, each of the polymeric ingredients (e.g., plastomer, low density polyethylene, and propylene polymer) may be added to the extruder at the feed throat of the extruder. The filler and other ingredients (e.g., nanoclay and flame retardant) that may be desirable may be added at the feed throat or within a subsequent stage or barrel of the extruder (e.g., downstream of the feed throat). This can be accomplished, for example, by using a side feeder. One or more of the polymeric ingredients may also be added downstream of the feed throat. This may include partial addition at the feed throat and partial addition downstream, or complete downstream addition of one or more polymeric ingredients.

In one or more embodiments, at least a portion of the nanoclay and/or flame retardant (e.g., ammonium polyphosphate) is added downstream of the feed throat. For example, at least 50% by weight, in other embodiments at least 75% by weight, in other embodiments at least 95% by weight, and in other embodiments at least 100% by weight of the flame retardant is added downstream of the feed throat.

In one or more embodiments, the nanoclay and/or flame retardant (e.g., ammonium polyphosphate) may be added downstream of the feed throat together with a carrier. The carrier may include a polymer having a melt flow rate in excess of about 10, in other embodiments in excess of about 5, and in other embodiments in excess of about 2. In one or more embodiments, the carrier may advantageously include one or more of the polymeric ingredients of the polymeric sheet.

The membranes of one or more embodiments of the present invention are useful in a number of applications. In one embodiment, the membranes may be useful for roofing membranes that are useful for covering flat or low-sloped roofs. In other embodiments, the membranes may be useful as geomembranes. Geomembranes include those employed as pond liners, water dams, animal waste treatment liners, and pond covers.

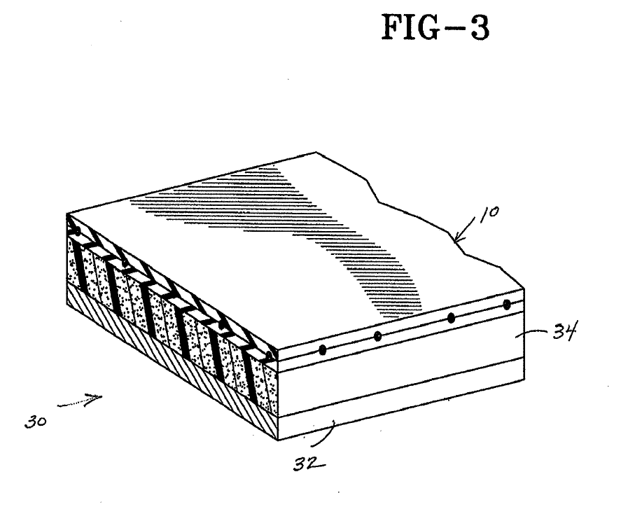

As described above, the membranes of one or more embodiments of the present invention may be employed as roofing membranes. These membranes include thermoplastic roofing membranes including those that meet the specifications of ASTM D-6878-03. These membranes maybe employed to cover flat or low/sloped roofs including built-up roofs. The membranes of the present invention are useful for covering roofs. In one or more embodiments, they can be used to create built-up roofs including flat and low-slope roofs. These roofs are generally known in the art as disclosed in U.S. Ser. Nos. 60/586,424 and 11/343,466, and International Application No. PCT/US2005/024232, which are incorporated herein by reference. As shown in FIG. 3, a flat or low-sloped built-up roof 30 may include a roof deck 32, and optional insulation layer 34, and membrane 10.

Practice of this invention is not limited by the selection of any particular roof deck. Accordingly, the roofing systems herein can include a variety of roof decks. Exemplary roof decks include concrete pads, steel decks, wood beams, and foamed concrete decks.

Practice of this invention is likewise not limited by the selection of any particular insulation board. Moreover, the insulation boards are optional. Several insulation materials can be employed including polyurethane or polyisocyanurate cellular materials. These boards are known as described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which is incorporated herein by reference.

In other embodiments, these membranes may be employed to cover flat or low-slope roofs following a re-roofing event. In one or more embodiments, the membranes may be employed for re-roofing as described in U.S. Publication No. 2006/0179749, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

Four thermoplastic compositions were prepared, fabricated into test samples, and tested to determine the propensity of the sample to allow flame spread. The samples included the ingredients set forth in Table I, which were mixed within a Brabender mixer operating at 50 rpm and set at an initial temperature of 175° C. Care was taken to ensure that the mixtures did not exceed 200° C.

The thermoplastic polymer blend included a plastomer, a propylene-based thermoplastic resin, and linear low density polyethylene. The plastomer, a portion of the linear low density polyethylene, and the propylene-based thermoplastic resin were pre-blended together and added to the mixer as a masterbatch. Also, the processing aid, the titanium dioxide, and the magnesium hydroxide (where used) were pre-blended as a dry blend together with linear low density polyethylene having a high MFR, and added to the mixer as a masterbatch. The masterbatch of the plastomer and propylene-based thermoplastic resin was added to the mixer first followed by the linear low density polyethylene. Upon melting, which took about 6 minutes, the dry blend masterbatch was added followed by the nanoclay.

TABLE I

| Sample | 1 | 2 | 3 | 4 |
|---|---|---|---|---|
| Ingredients (parts by weight) | | | | |
| Thermoplastic Polymer Blend | 100 | 100 | 100 | 100 |
| TiO₂ | 7.5 | 7.5 | 7.5 | 7.5 |
| Antioxidant | 0.4 | 0.4 | 0.4 | 0.4 |
| Light Stabilizer | 0.3 | 0.3 | 0.3 | 0.3 |
| Processing Additive | 0.8 | 0.8 | 0.8 | 0.8 |
| NanoClay | 5 | 3 | 5 | — |
| Flame Retardant | | | | |
| Ammonium Polyphosphate | 39 | 30 | — | 45 |
| Magnesium Hydroxide | — | 15 | 40 | 15 |
| Flame Spread Index | 1.0 | 1.18 | 1.18 | 1.27 |

The Samples were tested by employing a flame spread test similar to UL 94 except that the Samples were tested in a horizontal position. The values set forth in Table I are indexed, with the Sample exhibiting the least propensity to flame spread being indexed to one (1.0). The other Samples, which exhibited more propensity to spread flame, are reported with index numbers greater than one.

The nanoclay was obtained under the tradename NANOFIL™ SE3000 (Sud-Chemie). The ammonium polyphosphate was obtained under the tradename EXOLIT™ AP760 (Clariant). The magnesium hydroxide was obtained under the tradename VERTEX™ HST (J. M Huber).

Various modifications and alterations that do not depart from the scope and spirit of this invention will become apparent to those skilled in the art. This invention is not to be duly limited to the illustrative embodiments set forth herein.

What is claimed is:

1. A flexible polymeric laminate comprising:
a first layer including a thermoplastic resin having a nanoclay dispersed therein; and
a second layer including a thermoplastic resin having a filler dispersed therein, where said filler includes less than 1% by weight nanoclay.

2. The laminate of claim 1, where said first layer includes at least 3% by weight nanoclay.

3. The laminate of claim 2, where said second layer is substantially devoid of nanoclay.

4. The laminate of claim 1, where said first layer has a thickness of less than 30 mil.

5. The laminate of claim 1, where the laminate has a thickness of from about 45 mil to about 80 mil.

6. The laminate of claim 5, where the laminate is a roofing membrane, and the roofing membrane is in combination with a flat or low-sloped roof deck, and optional insulation board layer, and an optional recover board layer.

7. The laminate of claim 1, where the laminate has a thickness of from about 35 mil to about 120 mil.

8. The laminate of claim 7, where the laminate is a geomembrane, and the geomembrane is in combination with a body of water.

9. A flexible polymeric laminate comprising:
a first layer including an olefinic thermoplastic resin, from about 3 to about 10% by weight of a nanoclay, and a flame retardant;
a second layer including a thermoplastic resin and less than 3% by weight of a nanoclay; and
a reinforcing scrim.

10. The laminate of claim 9, where the first layer is characterized by a torsional stiffness of at least 2.0×10⁹ dynes/cm².

11. The laminate of claim 10, where the second layer is characterized by a torsional stiffness of less than 2.0×10⁹ dynes/cm².

12. The laminate of claim 11, where the first layer includes less than 30% by weight of the flame retardant.

13. The laminate of claim 12, where the flame retardant includes a char-layer forming flame retardant.

14. The laminate of claim 13, where the flame retardant is substantially devoid of compounds that decompose and release water upon decomposition.

15. The laminate of claim 14, where the char-layer forming flame retardant includes phosphates and phosphinates.

16. The laminate of claim 15, where the flame retardant includes ammonium polyphosphate, melamine polyphosphate, or a mixture thereof.

17. The laminate of claim 9, where the second layer is positioned between the first layer and the reinforcing scrim, and where the membrane includes one more polymeric layers adjacent to the scrim but opposite to the first and second layers.

18. The laminate of claim 9, where the laminate has a thickness of from about 45 mil to about 80 mil.

19. The laminate of claim 18, where the first layer has a thickness of from about 5 mil to about 20 mil.

20. The laminate of claim 19, where the laminate is a roofing membrane, and the roofing membrane is in combination with a flat or low-sloped roof deck, and optional insulation board layer, and an optional recover board layer.

21. The laminate of claim 9, where the first layer includes from about 5 to about 8% by weight nanoclay, and where the second layer includes less than 1% by weight nanoclay.

22. A roofing membrane comprising:
at least one polymeric layer including an olefinic thermoplastic polymer, a nanoclay, and a flame retardant that forms a char layers when placed in contact with a flame.

23. The membrane of claim 22, where the at least one polymeric layer includes from about 3% to about 10% by weight of the nanoclay.

24. The membrane of claim 22, where the at least one polymeric layer is characterized by a torsional stiffness of at least 2.0×10⁹ dynes/cm².

25. The membrane of claim 22, where the roofing membrane includes another polymeric layer characterized by a torsional stiffness of less than 2.0×10⁹ dynes/cm².

26. The membrane of claim 22, where the first layer includes less than 30% by weight of the flame retardant.
